(19) United States
(12) Patent Application Publication
(10) Pub. No.: US 2022/0029646 A1
(43) Pub. Date: Jan. 27, 2022

(54) RADIO FREQUENCY TRANSCEIVER FILTER CIRCUIT HAVING INTER-STAGE IMPEDANCE MATCHING

(71) Applicant: Corning Research & Development Corporation, Corning, NY (US)

(72) Inventors: Yury Abramov, Rosh Ha'Ain (IL); Jesus Anzoategui Cumana Morales, Berlin (DE)

(21) Appl. No.: 17/355,811

(22) Filed: Jun. 23, 2021

Related U.S. Application Data
(60) Provisional application No. 63/057,063, filed on Jul. 27, 2020.

(51) Int. Cl. H04B 1/00; H01Q 1/52

(52) U.S. Cl. CPC H04B 1/0057; H01Q 1/52

(57) ABSTRACT

A transceiver circuit is provided including a radio frequency antenna, a transceiver configured to transmit and receive an RF signal via the RF antenna and a filter circuit. The filter circuit including an antenna port in communication with the RF antenna first and second RF filters in a cascaded arrangement and in communication with the antenna port and configured to pass a first frequency band of the RF signal, a third RF filter in communication with the antenna port and configured to pass a second frequency band of the RF signal, and an impedance matching circuit disposed between the first RF filter and the second RF filter. The impedance matching circuit reduces reflection loss between the first RF filter and the second RF filter.

### CROSS-REFERENCE TO RELATED APPLICATIONS

This application claims the benefit of priority under 35 U.S.C. § 119 of U.S. Provisional Application Ser. No. 63/057,063, filed Jul. 27, 2020, the content of which is relied upon and incorporated herein by reference in its entirety.

### FIELD

The disclosure relates generally to wireless communications systems, and more particularly to filtering of RF communications signals in wireless communication systems.

### BACKGROUND

Wireless communication is rapidly growing, with ever-increasing demands for high-speed mobile data communication. Telecommunication networks and other networks utilize a plurality of discrete radio frequency (RF) bands with associated bandwidths to transmit and receive data between tower locations, distributed antenna systems (DAS), local area networks (LAN), or the like. Frequency-division duplexing (FDD) may be used in wireless communication networks, such as 3GPP, 4G LTE, 5G networks, or the like, to establish a full-duplex communications link using two different radio frequencies for transmitter and receiver operation, thereby allowing for simultaneous communication in both directions between two connected devices. FDD operation normally assigns the transmitter and receiver to different communication channels or frequencies. One frequency is used to communicate in one direction, and the other frequency is used to communicate in the opposite direction. The transmit direction and receive direction frequencies are separated by a defined frequency offset to reduce interference from the opposing frequency channel.

Many communications systems operate in a plurality of the RF bands enabling communication on the associated plurality of wireless networks. In some instances, an antenna may be utilized for multiple RF bands. RF filtering, such as bandpass filtering, in a wireless communications system may be utilized to isolate desired network bandwidth. Further, RF filtering may be utilized to isolate the receive, e.g. uplink (UL), signal from the transmit, e.g. downlink (DL) signal.

FIG. 1 illustrates an example front-end circuit including an FDD RF filter circuit, e.g. a diplexer 10. A front-end circuit may provide signal conditioning, such as filtering, amplification, multiplexing, or the like, to an analog RF signal between an RF antenna 12 and a transceiver. The diplexer 10 may be a three port device that receives incoming RF signals from a common antenna port P1 and splits the signal into a UL signal and a DL signal. The UL signal may be coupled to a first transceiver port P2 and the DL channel may be coupled to a second transceiver port P3. One or more RF filters may be utilized to pass the UL signal and/or the DL signal, and reject the opposing signal. In the depicted example a first RF filter, UL bandpass filter 14, is disposed between the antenna port P1 and the receiver port P2 for UL signal processing. Similarly, a second RF filter, DL bandpass filter 16, is disposed between the antenna port P1 and the transmit port P3 for DL signal processing. The UL bandpass filter 14 and the DL bandpass filter 16 may both be configured to pass a desired radio frequency or radio frequency range within an RF bandwidth and reject other radio frequencies. As shown, the amplitude the UL signal and DL signal may be approximately the same at the antenna port P1. The DL signal may be significantly reduced at the receive port P2 and the UL signal may be significantly reduced at the transmit port P3.

FIG. 2 illustrates an example front-end circuit including a diplexer 10′ having cascaded RF filtering to increase the rejection of out-of-band frequencies. The UL, DL, or both may include a second RF filter in series with the first RF filter to reduce the out-of-band frequencies. In the depicted embodiment both UL and DL signal paths include a second RF filter, e.g. UL bandpass filter 18 and DL bandpass filter 20. Comparing the UL and DL signals at the receiver port P2 and the transmission port P3 of the cascaded filter diplexer 10′ to the receiver port P2 and the transmission port P3 of the diplexer 10 of FIG. 1, the out-of-band signal frequency is substantially reduced.

### SUMMARY

In an example embodiment, a transceiver filter circuit is provided including a diplexer with cascaded RF filtering. The cascaded RF filtering includes an inter-stage impedance matching circuit, e.g. the matching circuit is disposed between a first RF filter and a second RF filter. The inter-stage impedance matching circuit may reduce or eliminate impedance mismatch between an output of the first RF filter and an input of the second RF filter. By matching the impedance between the cascaded RF filters signal reflection may be reduced and power transfer may be maximized to the second RF filter and ultimately to the transceiver and/or antenna.

In addition to the inter-stage matching circuit, the transceiver filter circuit may also include a phase shifter disposed between an antenna input and an RF filter. The phase shifter may be configured to transform, or shift, the input impedance of the filter in such a way as to present an open circuit (or high impedance) to those frequencies outside the passband of the RF filter. The resultant phase shift may limit or avoid loading or short circuiting the filter in the other branch.

In some embodiments, additional impedance matching may be performed before, such as a portion of the phase shifter, or after the RF filters. The additional impedance matching may further reduce reflectance losses in the front-end circuit and maximize power transfer.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 is a schematic diagram of a front-end circuit for signal conditioning in a wireless communication system including a diplexer according to an example embodiment;

FIG. 2 is a schematic diagram of a front-end circuit for signal conditioning in a wireless communication system including a diplexer having cascaded RF filtering according to an example embodiment;

FIG. 3 is a schematic diagram of a front-end circuit including a diplexer having cascaded RF filtering with inter-stage matching and a phase shifter according to an example embodiment;

FIG. 4 is a schematic diagram of a front-end circuit including a diplexer having cascaded RF filtering with interstate matching, a phase shifter, and a post matching circuit according to an example embodiment;

FIGS. 5A and 5B depict example smith charts for a diplexer channel without a phase shift and with a phase shift, respectively, according to an example embodiment;

FIG. 6 is a schematic diagram of an exemplary T-circuit for impedance matching according to an example embodiment;

FIG. 7 is a schematic diagram of an exemplary Pi-circuit for impedance matching according to an example embodiment;

FIG. 8 is a schematic diagram of an exemplary transmission line impedance matching circuit for impedance matching according to an example embodiment;

FIGS. 9A-9C illustrate a method for determining an inter-stage impedance matching according to an example embodiment;

FIG. 10 is a schematic diagram of a multiplexer transceiver filter circuit for mobile bands including inter-stage diplexer filtering according to an example embodiment;

FIG. 11 illustrates an example RF filter circuit according to an example embodiment;

FIG. 12 is a plot of the return loss and a Smith graph of the impedance of a single DL filter and a cascaded DL filter according to an example embodiment;

FIG. 13 is a plot of the return loss and a Smith graph of the impedance of a cascaded DL filter and a cascaded DL filter with inter-stage matching according to an example embodiment;

FIG. 14 is a plot of Voltage Standing Wave Ratio (VSWR) and a Smith graph of the impedance of a cascaded DL filter with inter-stage matching and a cascaded DL filter with inter-stage matching and input matching according to an example embodiment;

FIG. 15 is a plot of the return loss of a cascaded DL filter with input and post matching according to an example embodiment;

FIG. 16 is a plot of the return loss of a cascaded DL filter with input, inter-stage, and post matching according to an example embodiment;

FIG. 17 is a plot of the return loss of a single RF filter, cascaded RF filters with input phase shift and matching, and cascaded RF filters with input phase shift and matching, inter-stage matching, and post filtering matching according to an example embodiment; and

FIG. 18 is a plot of VSWR of a single RF filter, cascaded RF filters with input phase shift and matching, and cascaded RF filters with input phase shift and matching, inter-stage matching, and post filtering matching according to an example embodiment.

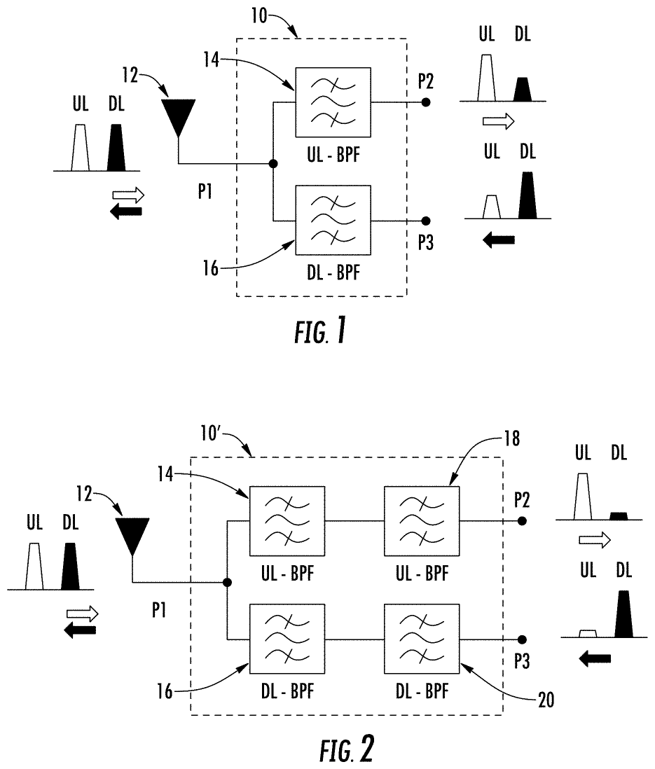

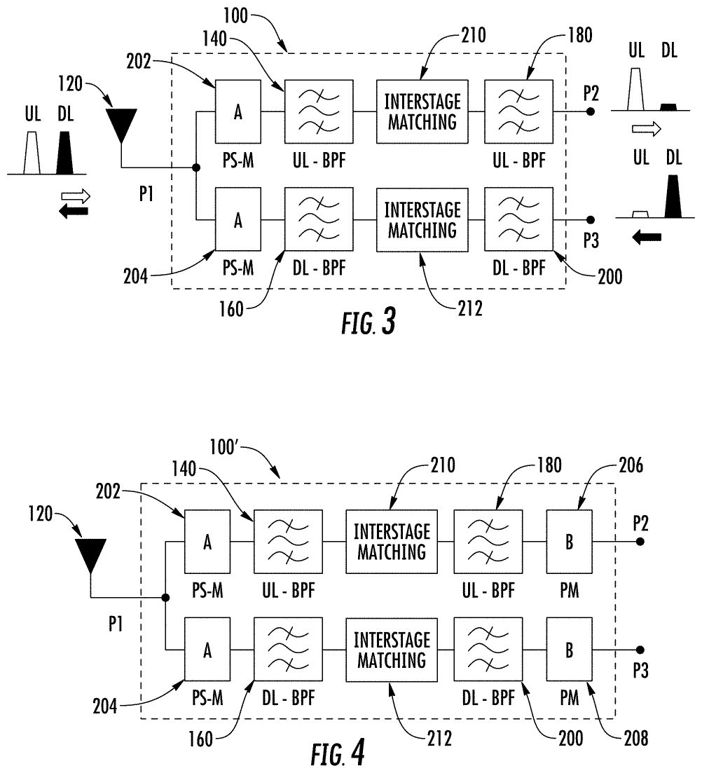

### DETAILED DESCRIPTION

Various embodiments will be further clarified by the following examples. A wireless communication system may include radio frequency (RF) filters for various purposes. One such purpose is to provide frequency-division duplexing (FDD). FDD may utilize a plurality of a RF filters, in a downlink (DL) and/or an uplink (UL) signal processing path in a wireless communication equipment to pass desired RF signals inside a predefined frequency range (“RF frequency”) and reject unwanted RF signals outside the predefined frequency range. For example, a cavity filter and a ceramic filter can both be configured to provide the RF filter functionalities. In many real-world implementations, the ceramic filter may be more preferable than the cavity filter because the ceramic filter is smaller and less expensive than the cavity filter. In some embodiments, surface acoustic wave (SAW), bulk acoustic wave (BAW), or the like may be utilized, such as in microstrip application in which even smaller circuit footprints are desired.

In some example embodiments, the UL or DL signal processing path, or branch, may utilize cascaded RF filtering to provide greater signal rejection of the unwanted RF signals. Cascaded RF filtering may result in an increase in in-band insertion loss, e.g. reflection, and deterioration of the input return loss of the diplexer caused by the conductor and/or dielectric of the RF filters. Additional passive circuitry around the RF filters, e.g. prior to or after the RF filters, may not address the losses generated by cascaded RF filtering. However, providing inter-stage impedance matching between cascaded RF filters may significantly reduce the return loss and reflection. Thereby increasing the power transfer and performance of the transmitter filter circuit.

As used herein, “RF filter” may generally refer to RF filters configured to pass some frequencies bands and reject others including without limitation, bandpass filters, lowpass filters, highpass filters, and band stop filters.

As used herein, “bandpass filter” may refer to a filter that may pass signals at frequencies within a specified frequency band and may reject signals at frequencies above the specified frequency band, as well as signals at frequencies below the specified frequency band.

As used herein, “diplexer” may refer to a three-port frequency-dependent device that may be used as a separator and/or a combiner of signals.

As used herein, “highpass filter” may refer to a filter that may pass signals at frequencies above a specified frequency and may reject signals at frequencies below the specified frequency.

As used herein, term “lowpass filter” may refer to a filter that may pass signals at frequencies below a specified frequency and may reject signals at frequencies above the specified frequency.

FIG. 3 illustrates a schematic diagram of an front-end circuit including a diplexer 100 having cascaded RF filtering with inter-stage matching. The diplexer 100 may be a three port device that receives incoming RF signals from a common antenna port P1, in communication, e.g. directly or indirectly electrically connected, with an antenna 120, and splits the signals into a UL signal and a DL signal. The UL signal may be coupled to a first transceiver port, e.g. the receive port P2, and the DL channel may be coupled to a second transceiver port, e.g. the transmit port P3. One or more RF filters may be utilized to pass the UL signal and/or the DL signal, and reject the opposing, out-of-band signal. The RF filters may include a high pass filter, a low pass filer, and/or a bandpass filter. In the depicted example, a first UL bandpass filter 140 is disposed in communication with the antenna port P1 and second UL bandpass filter 180 is disposed between the first UL bandpass filter 140 and a receiver port P2 for UL signal processing. Similarly, a first DL bandpass filter 160 is disposed in communication with antenna port P1 and a second DL bandpass filter 200 is disposed between first DL bandpass filter 16 and the transmit port P3 for DL signal processing. The first UL bandpass filter 140 and the DL bandpass filter may both be configured to pass a desired radio frequency or radio frequency range within an RF bandwidth and reject other radio frequencies. Although the depicted embodiment includes cascaded bandpass filters in both the UL and DL signal branches, other filter configurations are also contemplated. For example, the UL signal branch may include a bandpass filter and the DL signal branch may include a cascaded highpass filter and lowpass filter. Additionally, the RF filters of the diplexer 100 may include one or more of a cavity filter, a ceramic filter, a surface acoustic wave (SAW) filter, a bulk acoustic wave (BAW) filter, or the like.

In an example embodiment, the diplexer 100 may include a phase shifter 202 disposed between the antenna port P1 and the first UL bandpass filter 140 and/or a phase shifter 204 dispose between antenna port P1 and the first DL bandpass filter 160. The phase shifters 202,204 may transform, or shift, the phase angle of the input impedance of the first bandpass filters 140,160 to present an open circuit, or high impedance, to frequencies outside of the pass band for the respective bandpass filter 140, 160. The phase shifter 202, 204 may limit or prevent loading or shorting of an RF filter is the opposite signal branch. FIG. 5A depicts a smith chart of the input impedance of a SAW filter for operation in the DL spectrum of the PCS band, 1930-1995 MHz. The impedance presented to the UL portion of the spectrum, 1850-1915 MHz, is close to the short circuit region on the smith chart. FIG. 5B depicts the input impedances of FIG. 5A after rotation by a phase shifter. The resulting input impedance is shifted around the center and moved them towards the open circuit region for the UL portion of the smith chart. The phase shifter 202, 204 may be any suitable analog phase shifter including, without limitation, one conductor or dielectric transmission line, two conductor transmission line, or the like. In some embodiments, the phase shifters 202,204 may also provide prefilter impedance matching between the antenna port P1 and the first UL bandpass filter 140 or the first DL bandpass filter 160.

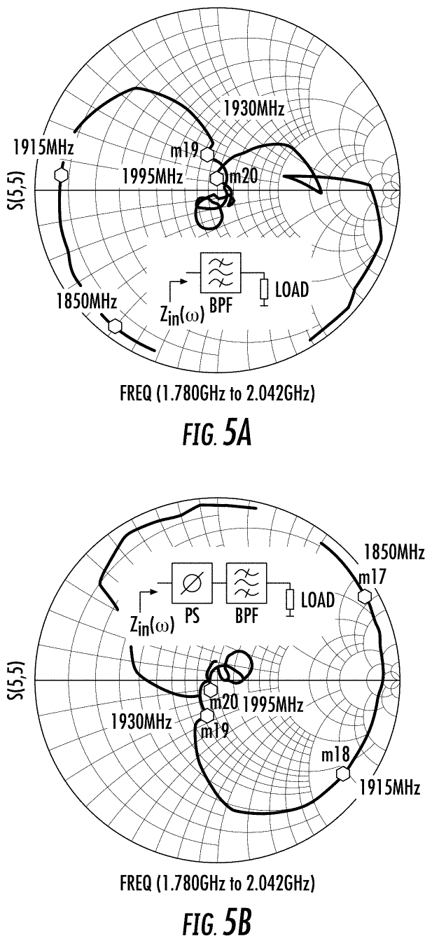

Similarly, a post filtering impedance matching circuit 206 may be disposed between the receiver port P2 and the UL bandpass filters and/or a post filtering impedance matching circuit 208 may be disposed between the transmit port P3 and the DL bandpass filters, as shown in FIG. 4. The prefilter impedance matching of the phase shifters 202, 204 may reduce reflectance of out-of-band frequencies, or insertion loss, and increase the power transfer of the diplexer 100′ before the RF filters, by correcting the impedance mismatch between the antenna 12 and the first UL bandpass filter 140 and/or the antenna 12 and the first DL bandpass filter 160. The post filtering impedance matching circuit 206, 208 may similarly reduce the reflectance of out-of-band frequencies and increase the power transfer of the diplexer 100 after the RF filters, by correcting the impedance mismatch between the load, e.g. the transmitter or receiver of the transceiver, and the second UL bandpass filter 180 and/or the load and the second DL bandpass filter 200. The post filtering impedance matching circuits 206,208, may be a T-circuit, a Pi-circuit, or a transmission line impedance element, as discussed in FIGS. 6-8, or any other suitable impedance matching circuit architecture.

In an example embodiment, the diplexer 100, 100′ may include an inter-stage impedance matching circuit configured to reduce the reflection loss due to an impedance mismatch between cascaded RF filters, and to increase the power transfer from the first to the second RF filter. In the example embodiments depicted in FIGS. 3 and 4, an impedance matching circuit is disposed in both the UL signal branch and the DL signal branch, however, the inter-stage impedance matching may be utilized in in just one of the UL or DL signal branches. Continuing with the depicted embodiments, a first inter-stage impedance matching circuit 210 may be disposed between the first UL bandpass filter 140 and the second UL bandpass filter 180. Similarly, a second inter-stage impedance matching circuit 212 may be disposed between the first DL bandpass filter 160 and the second UL bandpass filter 200. The inter-stage impedance matching circuits 210, 212 may be a T-circuit, a Pi-circuit, or a transmission line impedance element, as discussed in FIGS. 6-8, or any other suitable impedance matching circuit architecture.

FIG. 6 is a schematic diagram of an example T-circuit 300, sometime referred to as a “T-network”, that may be utilized in inter-stage impedance matching circuits, as described above. The T-circuit 300 may utilize a combination of inductors and capacitors arranged such that the top of the T is disposed between the cascaded bandpass filters and the stem of the T is connected to ground. The T-circuit 300 may include a low pass T-network having two inductors in series between the cascaded bandpass filters and a capacitor disposed in the stem line. Alternatively, the T-circuit may include a LCC network having an inductor and a capacitor in series between the cascaded RF filters and a second capacitor connected between the cascaded RF filters and ground.

FIG. 7 is a schematic diagram of an example Pi-circuit 310, sometime referred to as a “p-network”, that may be utilized in inter-stage impedance matching circuits, as described above. The Pi-circuit 310 may utilize a combination of inductors and capacitors arranged such that the top of the Pi is disposed between the cascaded bandpass filters and the two stems of the Pi are connected to ground. The Pi-circuit 310 may be a low pass p network having an inductor disposed between the cascaded RF filters and a capacitor may be disposed in each of the two stem lines. Alternatively, the Pi-circuit 310 may be a high pass p network having a capacitor disposed between the cascaded RF filters and an inductor may be disposed in each of the two stem lines.

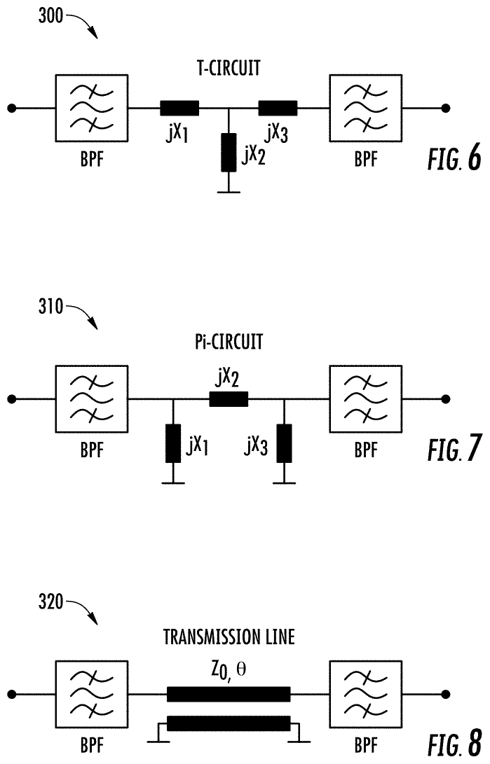

FIG. 8 is a schematic diagram of an example transmission line impedance matching element 320. The transmission line may include characteristic impedances Z₀ and electrical length θ.

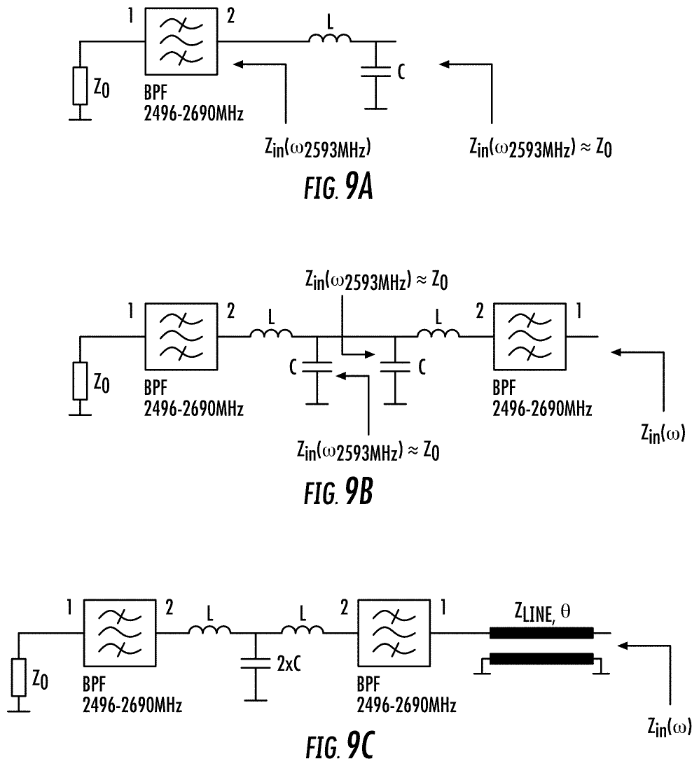

The values of the inductors, capacitors and transformers described in each of the example impedance matching circuits of FIGS. 6-8 may be selected to offset the impedance mismatch between the cascaded RF filters. An example determination of T-circuit component values is depicted in FIGS. 9A-9C. The impedance matching circuits discussed in FIGS. 6-8 are merely for merely illustrative purposes, other impedance matching circuits are also contemplated including, without limitation, matching stubs, transmatch circuit, split capacitor network, L network, Q-transformers, or the like. However, complex matching network topologies may not be required since the input impedance of the RF filters, such as bandpass filters, do not differ dramatically from the reference impedance of the system (Z₀=50Ω in the example depicted in FIGS. 9A-9C), in contrast to an active device, such an RF high-power field-effect transistor in which impedances of few ohms are encountered.

FIGS. 9A-9C depict a determination of impedance matching circuit values for components of an inter-stage impedance matching circuit in TDD band 2496-2690 MHz. First, at FIG. 9A, the input impedance is determined at port 2 of the bandpass filter with port 1 connected to system impedance. Here Z₀ equals fifty (50) ohms. Next, an L-C network may be utilized to convert the complex input impedance at the mid-frequency to a real value close to Z₀. Conventional impedance network synthesis methods and impedance matching techniques may be utilized, as known in the art. A back-to-back connection of bandpass filters and associated matching network is depicted in FIG. 9B. The measured impedance of both the left and right sides of the back-to-back connection should be Z₀ at the mid-frequency. Next, the values of the capacitors (C) and inductors (L) may be set to obtain a sufficient matching of Zᵢₙ(ω) to Z₀ over the full frequency range. In FIG. 9C a transmission line phase shifter has been added to the input of the left bandpass filter. The length of the transmission line element may be determined to rotate the impedance of the second band, e.g. the opposite of the UL or DL band for which the filter circuit is intended. The line impedance is then set to obtain a sufficient matching of Zᵢₙ(ω) to Z₀ over the full frequency range. In some embodiments, fine tuning or adjustments of the inductors, capacitors, or transmission line element may be performed to achieve sufficient matching of Zᵢₙ(ω) to Z₀ over the full frequency range for the complete circuit.

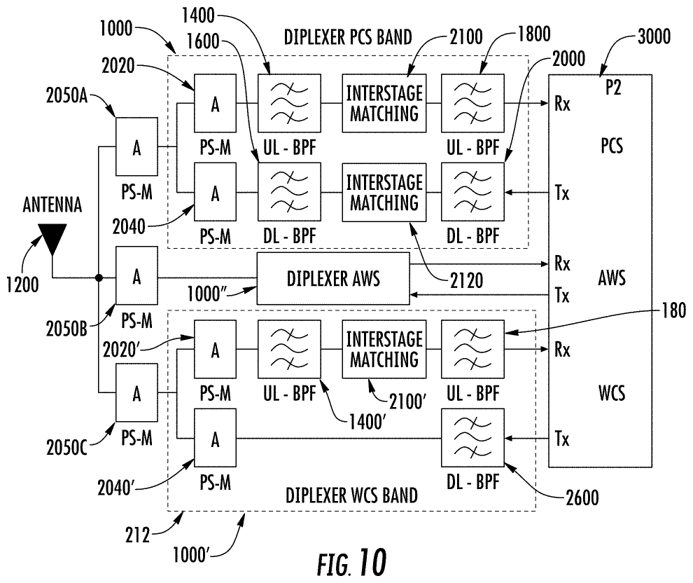

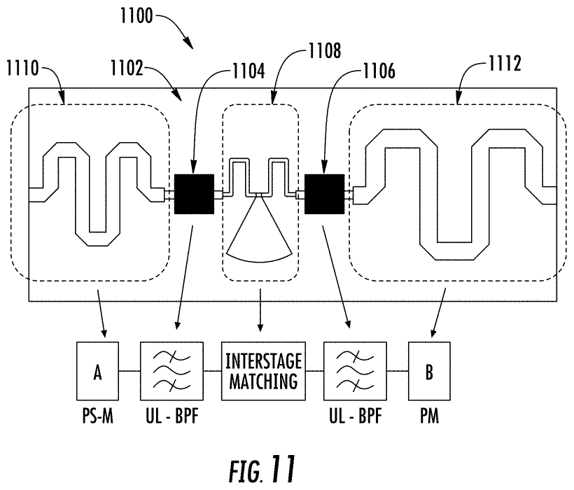

Turning to FIG. 10, an example transceiver circuit including a multiplexer configured for personal communication service (PCS) band, advanced wireless service (AWS) band, and wireless communication service (WCS) band. The depicted bands are merely for illustrative purposes, other radio frequency bands may be utilized. The transceiver circuit may include an antenna 1200, a plurality of diplexers 1000, 1000′ 1000″, and a transceiver 3000. The transceiver 3000 may be configured to receive analog RF signals from each of the plurality of diplexers 1000, 1000′, 1000″ and convert the analog signals into a digital communication signal that may be further processed by a communication device. Each of the diplexers 1000, 1000′, 1000″ may be associated with a phase shifter 2050A, 2050B, 2050C disposed between the antenna 1200 and the respective diplexer 1000, 1000′, 1000″. The phase shifters 2050A, 2050B, 2050C may shift or rotate the phase angle of the input impedance of the diplexer to present an open circuit, or high impedance, to frequencies outside of the pass band for the respective diplexer. In some example embodiments, the phase shifters 2050A, 2050B, 2050C may also provide prefilter impedance matching.

The transceiver 3000 may include a plurality of receive and transmit ports. Each of the receive and transmit ports may be arranged in pairs and be in communication, such as electrically connected to a respective diplexer 1000, 1000′, 1000″. In an example embodiment, the UL signal branch port of the diplexer may be connected to the receive port of the transceiver 3000 and the DL signal branch port of the diplexer may be connected to the transmit port of the transceiver 3000.

The PSC band diplexer 1000 may include cascaded RF filters including a first UL bandpass filter 1400 and a second UL bandpass filter 1800, as well as a first DL bandpass filter 1600 and a second DL bandpass filter 2000. The PCS band diplexer 1000 may include a phase shifter 2020 disposed between the antenna port and the first UL bandpass filter 1400 and a phase shifter 2040 disposed between the antenna port and the first DL bandpass filter 1600. The phase shifters 2020, 2040 may shift or rotate the phase angle of the input impedance of the first bandpass filters 1400,1600 to present an open circuit, or high impedance, to frequencies outside of the pass band for the respective first bandpass filters 1400, 1600. In some example embodiments, the phase shifters 2020, 2040 may also provide prefilter impedance matching. The depicted diplexer includes cascaded bandpass filters. However, other RF filter configurations, such as cascaded lowpass filters and high pass filters or combinations of lowpass filters, highpass filters, and/or bandpass filters are also contemplated. The PCS band diplexer 1000 includes a first inter-stage impedance matching circuit 2100 disposed between the first UL bandpass filter 1400 and the second UL bandpass filter 1800. The PCS band diplexer 1000 also includes a first inter-stage impedance matching circuit 2120 disposed between first DL bandpass filter 1600 and a second DL bandpass filter 2000. The inter-stage impedance matching circuits 2100, 2120 are configured to reduce the reflection loss due to an impedance mismatch between cascaded RF filters, and to increase the power transfer from the first to the second RF filter.

The WCS band diplexer 1000′ may include cascaded RF filters in the UL signal branch including a first UL bandpass filter 1400′ and a second UL bandpass filter 1800′. The DL signal branch may include a single RF filter, DL bandpass filter 2600. The WCS band diplexer 1000′ may include a phase shifter 2020′ disposed between the antenna port and the first UL bandpass filter 1400′ and a phase shifter 2040′ disposed between the antenna port and the DL bandpass filter 2600. The phase shifters 2020′, 2040′ may shift or rotate the phase angle of the input impedance of the bandpass filters 1400′,2600 to present an open circuit, or high impedance, to frequencies outside of the pass band for the respective bandpass filters 1400′, 2600. In some example embodiments, the phase shifters 2020′, 2040′ may also provide prefilter impedance matching. The depicted diplexer 1000′ includes cascaded bandpass filters. However, other RF filter configurations, such as cascaded lowpass filters and high pass filters or combinations of lowpass filters, highpass filters, and/or bandpass filters are also contemplated. The WCS band diplexer 1000′ includes an inter-stage impedance matching circuit 2100′ disposed between the first UL bandpass filter 1400′ and the second UL bandpass filter 1800′. The inter-stage impedance matching circuit 2100′ is configured to reduce the reflection loss due to an impedance mismatch between cascaded RF filters, and to increase the power transfer from the first to the second RF filter.

The AWS band diplexer 1000″ is depicted as a block diagram to simplify the schematic diagram of transceiver circuit. The AWS band diplexer 1000″ may be similar to the PCS band diplexer 1000 including cascaded RF filters on both the UL signal branch and DL signal branch, with or without inter-stage impedance matching, or the AWS band diplexer 1000″ may be similar to the WCS band diplexer 1000′ including one cascaded RF filter branch and a bandpass filter branch. Alternatively, the AWS band diplexer 1000″ may include bandpass filters in both the UL and DL signal branches, without cascading RF filters.

FIG. 11 depicts an example embodiment of an RF filter circuit 1100 disposed on a microstrip 1102. The RF filter circuit may be a signal branch, e.g. UL or DL, of a diplexer, such as discussed above. Alternatively, the RF filter circuit may be an individual RF filter or signal branch of a multiplexer. RF filter circuit 1100 may include cascading RF filters, such as a first bandpass filter 1104 and a second bandpass filter 1106. In an example embodiment, the bandpass filters 1104 and 1106 may be SAW or BAW bandpass filters. The RF filter circuit 1100 may include an inter-stage impedance matching circuit 1108 disposed between the first bandpass filter 1104 and the second bandpass filter 1106. In an example embodiment, the inter-stage impedance matching circuit 1108 may be a T-circuit formed of two meander transmission lines, which behave like inductors and a radial taper which displays a capacitive response over frequency.

The RF filter circuit 1100 may include a phase shifter 1110 disposed at an input to the first bandpass filter 1104. The phase shifter 1110 may be formed from meander transmission lines. In some example embodiments, the phase shifter 1110 may also provide prefilter impedance matching. The RF filter circuit 1100 may include a post filtering impedance matching circuit 1112 disposed at the outlet of the second bandpass filter 1106. The post filtering impedance matching circuit 1112 may also be formed from a meander transmission lines. The meander transmission lines of the phase shifter 1110 and/or the post filtering impedance matching circuit 1112 may be relatively thicker than the meander transmission lines of the inter-stage impedance matching circuit 1108.

FIG. 12 is a plot of the return loss and a smith graph of the impedance of a single DL filter (grey) and a cascaded DL filter (black) operating in the PCS band (1930-1995) MHz. When cascading two DL filters the return loss around the mid-frequency degrades going from 13.2 dB to 8.6 dB. This effect can also be seen in the smith chart in which the impedance moves away from the center, taking a real value of approximately 30.5Ω.

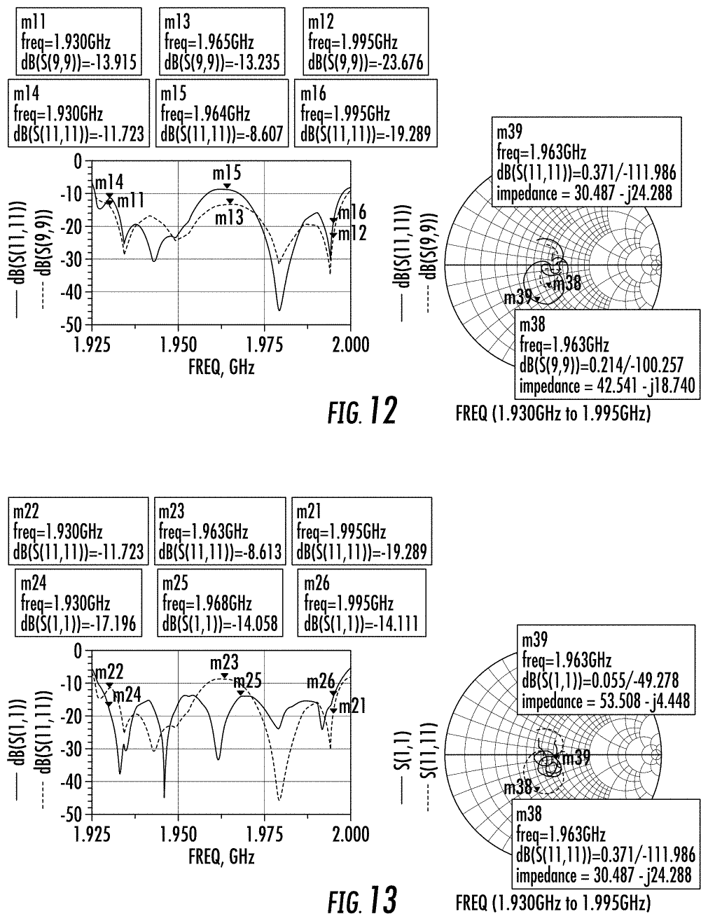

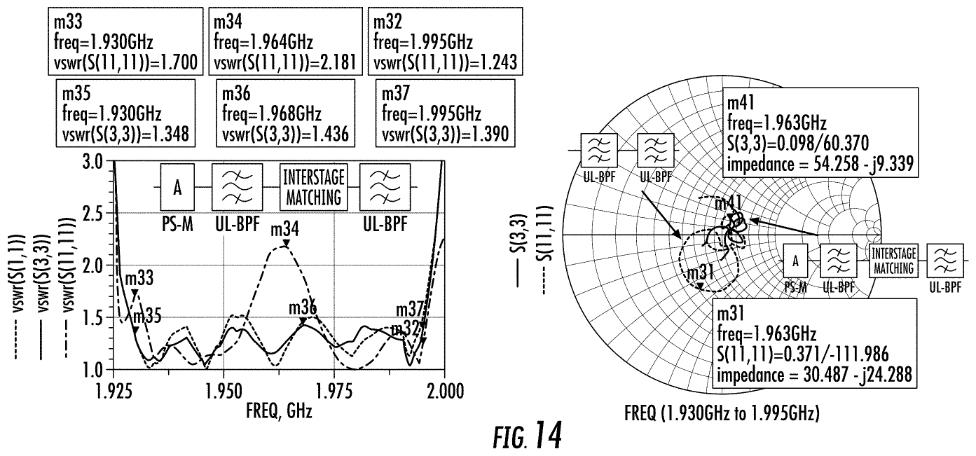

By using inter-stage matching, the return loss may be improved over the whole frequency range, the worst return loss being 14 dB in the example depicted in FIG. 13, as the impedances move towards the center of the smith chart. The a cascaded DL filter is depicted in grey and a cascaded DL filter with inter-stage matching is depicted in black. The addition of a transmission line, as the phase shifter and input matching element, provides a minor improvement as indicated by the Voltage Standing Wave Ratio (VSWR) and impedance plots of FIG. 14. A cascaded DL filter without inter-stage matching is depicted in grey, a cascaded DL filter with inter-stage matching is depicted in dashed line, and a cascaded DL filter with inter-stage matching and input matching is depicted in black.

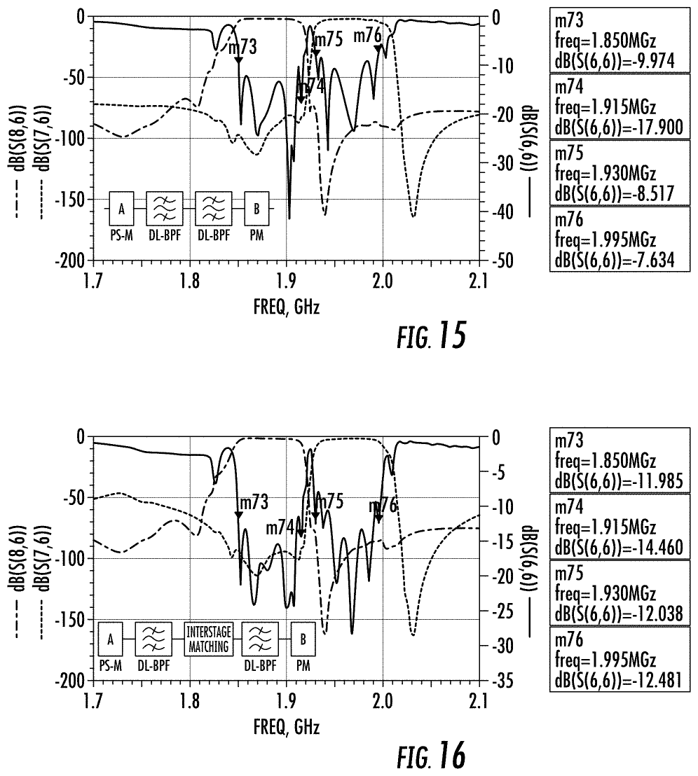

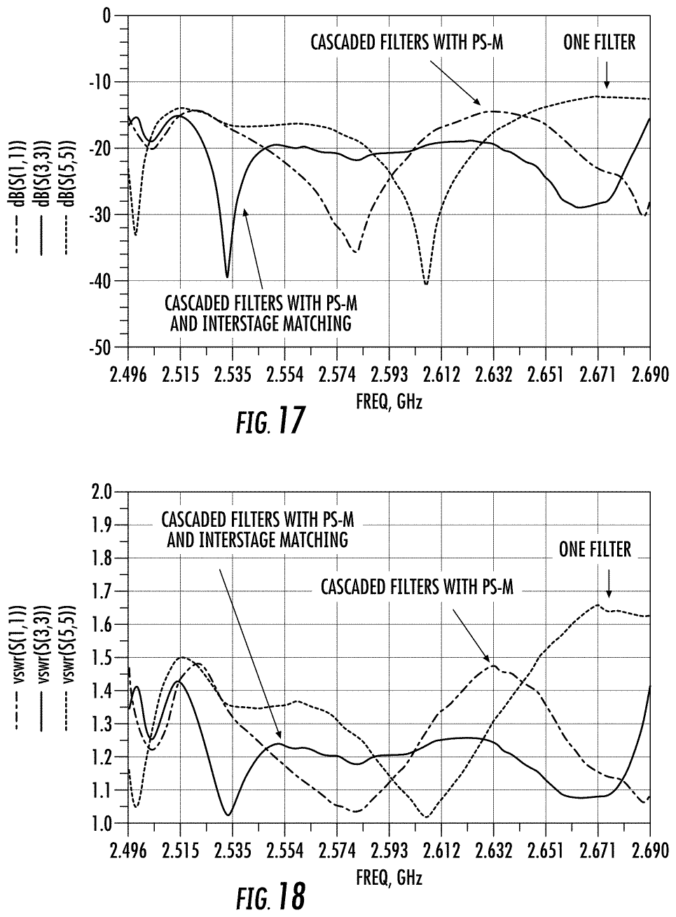

FIGS. 15 and 16 depict results of the whole PCS diplexer using cascaded SAW filters for the UL and DL branches. Using interstage matching allows obtaining return loss values better than 12 dB (FIG. 16), the worst case being around 7.6 dB without inter-stage matching (FIG. 15).

FIGS. 16 and 17 illustrate the return loss and VSWR, respectively, of two cascaded ceramic filters operating in the TDD band (2.496-2.690) GHz. The single filter is shown as reference in grey color, whereas the cascaded filters response in black color. Although the cascaded filters without inter-stage matching (dashed line) display a good overall return loss better than 10 dB with worst case of 14 dB, the inter-stage matching allows obtaining better than 18 dB over most of the frequency range (2.523-2.687) GHz with worst case return loss of 15 dB.

In an example embodiment, a transceiver filter circuit is provided including an antenna port configured to transmit or receive a radio frequency (RF) signal via an RF antenna, a first RF filter in communication with the antenna port and configured to pass a first frequency band of the RF signal, a second RF filter in communication with an output of the first RF filter and configured to pass the first frequency band, a third RF filter in communication with the antenna port and configured to pass a second frequency band of the RF signal. The second frequency band is different from the first frequency band. The transceiver filter circuit may also include an impedance matching circuit disposed between the first RF filter and the second RF filter. The impedance matching circuit reduces reflection loss between the first RF filter and the second RF filter.

In some example embodiments, the transceiver filter circuit also includes a fourth RF filter in communication with an output of the third RF filter and configured to pass the second frequency band and a second impedance matching circuit disposed between the third RF filter and the fourth RF filter. The impedance matching circuit reduces the reflection loss between the third RF filter and the fourth RF filter. In an example embodiment, the transceiver filter circuit also includes a first phase shifter disposed between the antenna port and the first RF filter and a second phase shifter disposed between the antenna port and the third RF filter. In some example embodiments, the first phase shifter and the second phase shifter provide impedance matching between the antenna port and the first RF filter and the third RF filter, respectively. In an example embodiment, the first phase shifter or second phase shifter comprise a meander transmission line. In some example embodiments, the transceiver filter circuit of claim also includes a first post filtering impedance matching circuit disposed between the second RF filter and a first transceiver port and a second post filtering impedance matching circuit disposed between the third RF filter and a second transceiver port. In an example embodiment, the first RF filter, the second RF filter, or the third RF filter includes a surface acoustic wave (SAW) filter. In some example embodiments, the first RF filter, the second RF filter, or the third RF filter includes a bulk acoustic wave (BAW) filter. In an example embodiment, the impedance matching circuit includes a T-circuit, a Pi circuit, or a transmission line impedance element. In some example embodiments, the first RF filter, the second RF filter, and the third RF filter comprise one of a lowpass filter, a highpass filter, or a bandpass filter.

In another example embodiment, a transceiver circuit is provided including a radio frequency (RF) antenna; a transceiver configured to transmit and receive an RF signal via the RF antenna, and a filter circuit. The filter circuit includes an antenna port in communication with the RF antenna, a first RF filter in communication with the antenna port and configured to pass a first frequency band of the RF signal, a second RF filter in communication with an output of the first RF filter and configured to pass the first frequency band, a third RF filter in communication with the antenna port and configured to pass a second frequency band of the RF signal that is different from the first frequency band, and an impedance matching circuit disposed between the first RF filter and the second RF filter. The impedance matching circuit reduces reflection loss between the first RF filter and the second RF filter.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A transceiver circuit comprising:
a radio frequency (RF) antenna;
a transceiver configured to transmit and receive an RF signal via the RF antenna; and
a filter circuit comprising:
an antenna port in communication with the RF antenna;
a first RF filter in communication with the antenna port and configured to pass a first frequency band of the RF signal;
a second RF filter in communication with an output of the first RF filter and configured to pass the first frequency band;
a third RF filter in communication with the antenna port and configured to pass a second frequency band of the RF signal, wherein the second frequency band is different from the first frequency band; and
an impedance matching circuit disposed between the first RF filter and the second RF filter, wherein the impedance matching circuit reduces reflection loss between the first RF filter and the second RF filter.

2. The transceiver circuit of claim 1 further comprising:
a fourth RF filter in communication with an output of the third RF filter and configured to pass the second frequency band; and
a second impedance matching circuit disposed between the third RF filter and the fourth RF filter, where the impedance matching circuit reduces the reflection loss between the second RF filter and the fourth RF filter.

3. The transceiver circuit of claim 1 further comprising:
a first phase shifter disposed between the antenna port and the first RF filter; and
a second phase shifter disposed between the antenna port and the third RF filter.

4. The transceiver circuit of claim 3, wherein the first phase shifter and the second phase shifter provide impedance matching between the antenna port and the first RF filter and the third RF filter, respectively.

5. The transceiver circuit of claim 4, wherein the first phase shifter or the second phase shifter comprise a meander transmission line.

6. The transceiver circuit of claim 1, further comprising:
a first post filtering impedance matching circuit disposed between the second RF filter and a first transceiver port; and
a second post filtering impedance matching circuit disposed between the third RF filter and a second transceiver port.

7. The transceiver circuit of claim 1, wherein the first RF filter, the second RF filter, or the third RF filter comprises a surface acoustic wave (SAW) filter.

8. The transceiver circuit of claim 1, wherein the first RF filter, the second RF filter, or the third RF filter comprises a bulk acoustic wave (BAW) filter.

9. The transceiver circuit of claim 1, wherein the impedance matching circuit comprises a T-Circuit, a Pi circuit of a transmission line impedance element.

10. The transceiver circuit of claim 1, wherein the first RF filter, the second RF filter, and the third RF filter comprise one of a lowpass filter, a highpass filter, or a bandpass filter.

11. A transceiver filter circuit comprising:
an antenna port configured to transmit or receive a radio frequency (RF) signal via an RF antenna;
a first RF filter in communication with the antenna port and configured to pass a first frequency band of the RF signal;
a second RF filter in communication with an output of the first RF filter and configured to pass the first frequency band;
a third RF filter in communication with the antenna port and configured to pass a second frequency band of the RF signal, wherein the second frequency band is different from the first frequency band; and
an impedance matching circuit disposed between the first RF filter and the second RF filter, wherein the impedance matching circuit reduces reflection loss between the first RF filter and the second RF filter.

12. The transceiver filter circuit of claim 11 further comprising:
a fourth RF filter in communication with an output of the third RF filter and configured to pass the second frequency band; and
a second impedance matching circuit disposed between the third RF filter and the fourth RF filter, where the impedance matching circuit reduces the reflection loss between the third RF filter and the fourth RF filter.

13. The transceiver filter circuit of claim 11 further comprising:
a first phase shifter disposed between the antenna port and the first RF filter; and
a second phase shifter disposed between the antenna port and the third RF filter.

14. The transceiver filter circuit of claim 13, wherein the first phase shifter and the second phase shifter provide impedance matching between the antenna port and the first RF filter and the third RF filter, respectively.

15. The transceiver filter circuit of claim 14, wherein the first phase shifter or the second phase shifter comprise a meander transmission line.

16. The transceiver filter circuit of claim 11, further comprising:
a first post filtering impedance matching circuit disposed between the second RF filter and a first transceiver port; and
a second post filtering impedance matching circuit disposed between the third RF filter and a second transceiver port.

17. The transceiver filter circuit of claim 11, wherein the first RF filter, the second RF filter, or the third RF filter comprises a surface acoustic wave (SAW) filter.

18. The transceiver filter circuit of claim 11, wherein the first RF filter, the second RF filter, or the third RF filter comprises a bulk acoustic wave (BAW) filter.

19. The transceiver filter circuit of claim 11, wherein the impedance matching circuit comprises a T-Circuit, a Pi circuit, or a transmission line impedance element.

20. The transceiver filter circuit of claim 11, wherein the first RF filter, the second RF filter, and the third RF filter comprise one of a lowpass filter, a highpass filter, or a bandpass filter.
